(19) United States
(12) Patent Application Publication
(10) Pub. No.: US 2007/0218796 A1
(43) Pub. Date: Sep. 20, 2007

(54) Paper composite for billboards and banners

(76) Inventor: Peter C. Yao, Pickerington, OH (US)

Correspondence Address: RATNERPRESTIA, P.O. BOX 1596, WILMINGTON, DE, 19899, US

(21) Appl. No.: 11/724,822

(22) Filed: Mar. 16, 2007

Related U.S. Application Data
(60) Provisional application No. 60/783,338, filed on Mar. 17, 2006.

(51) Int. Cl. B32B 37/00; B31B 1/60; B32B 29/02

(52) U.S. Cl. 442/412; 428/537.5; 428/425.1; 428/511; 156/60; 156/277; 40/615

(57) ABSTRACT

A paper composite for use on billboards, including at least one water-resistant paper outer layer impregnated with a polymeric resin, and having one or more pigmented or clear coatings suitable for high quality printing on the surface of the paper, the composite optionally also including a reinforcing lightweight polymeric fabric.

A method of applying a visible textual or pictorial image to a billboard includes attaching a composite of this invention, with an image on it, to the billboard.

A method of forming a composite of this invention includes adhering together a polymeric fabric and a paper sheet and, either before or after the adhering step, impregnating the paper sheet with a first synthetic polymeric resin in an amount sufficient to render the sheet water-resistant and thereafter applying a coating layer on the paper sheet.

### CROSS REFERENCE TO RELATED APPLICATIONS

This patent application claims priority of U.S. Provisional patent application No. 60/783,338, filed Mar. 17, 2006, the entire disclosure of which is incorporated herein by reference.

### BACKGROUND OF THE INVENTION

Currently, available substrates for billboards, signage, banners, and displays are made of various sheet materials. While each of the materials currently available has properties tailored for digital printers, they are all lacking in one or more of the properties needed for billboard, signage, banners, and displays, such as durability, strength, and print quality. Typical advantages and disadvantages of various materials used for billboards are listed in the following table.

| Material | Advantages | Disadvantages |
|---|---|---|
| Paper | Good print quality, | Poor strength and durability |
| | light weight | |
| PVC | Durable and strong | Poor print quality, heavy weight, |
| | | lacks stiffness |
| TYVEK | Durable and strong | Poor ink adhesion/print quality, |
| | | high cost, slippery, noisy under |
| | | high wind, lacks stiffness |
| Polypropylene | Durable and strong | Poor ink adhesion/print |
| | | quality, marginal tear resistance, |
| | | lacks stiffness |

Typical commercially available paper-based billboard substrates are made of highly sized paper stock and are coated to improve water resistance. With is highly sized, coated paper, print quality is usually very good. However, such paper substrates typically lack the good tensile and tear strengths that are usually provided by plastic films.

Commonly used substrate sheets using reinforced polyvinyl chloride (PVC), often used for outdoor applications, typically consist of two layers of PVC, with a middle layer of a polyester scrim. Other polymers may also be used, for example TYVEK® flash-spun polyethylene fabric, available from E. I. du Pont de Nemours and Company of Wilmington, Del.

Specifically, PVC-based material is durable (resistant to water and UV-light), strong (high tensile and tear), but produces poor print quality when used with solvent-based inkjet. In addition, PVC film is not suitable for water-based inkjet and laser print applications. Printing of PVC film using water-based inkjet can result in smudging due to slow drying and poor adhesion of the water-based ink to the substrate. In addition, PVC film will melt under the high temperature and nip pressure of the fuser compartment of laser printers, causing it to jam the machine. Both polypropylene and TYVEK films have similar characteristic as PVC-based material and therefore, have similar disadvantages as PVC-based material.

It is well known that stretching (or drawing) films of polyethylene or other linear thermoplastic polymers decreases the thickness (and weight), as well as increasing its tensile and tear strengths, due to molecular alignment. For applications requiring strength in both CD and MD directions, biaxial stretching is required. It is also known that laminating polymeric films to other substrates, such as paper, improves its strength (tear and tensile), stiffness, and water/oil permeability.

In laminating paper substrates to polyethylene films, an adhesive tie-layer is generally required for the laminates to bond. The adhesive layer, ethylene vinyl acetate copolymer or EVA, can either be thermo-applied between the substrate and film, or extrusion coated on-site. Laminating a biaxially stretched linear polymer film to paper substrate can potentially be used to produce a material for billboard, signage, banners, and displays. However, several difficulties may be experienced with this method, namely:

1. Application is complicated and slow, due to the added adhesive tie-layer.

2. The process is expensive, either because an extruder is required, or the added cost of the adhesive tie layer.

3. Dimensional stability-related problems such as waviness and curl are difficult to resolve, due to the different thermal- and humidity-related expansion between the paper substrate, biaxial film, and adhesive tie-layer.

4. As a result of the dimensional stability mentioned above, using the composite for billboard, signage, banners, and displays requires higher stiffness and basis weight. Both the higher stiffness and the higher weight make transporting and mounting the composite on a billboard more difficult.

### SUMMARY OF THE INVENTION

In one aspect, the invention provides a paper composite. The composite includes a first paper sheet having a first side and a second side, and the paper sheet is impregnated with a first synthetic polymeric resin in an amount sufficient to render the sheet water-resistant. On the first side of the paper sheet is a coating layer including a second polymeric resin. The paper sheet has a basis weight in a range from 10 to 60 lbs/1300 ft², and the first synthetic polymeric resin has an elongation at break of at least 60% by ASTM method D638.

In another aspect, the invention provides a method of applying a visible textual or pictorial image to a billboard. The method includes providing a billboard including a flat side, and attaching a substantially coextensive paper composite as defined in the preceding paragraph onto the flat side, bearing on it the visible pictorial or textual image.

In yet another aspect, the invention provides a method of forming a paper composite. The method includes a step of adhering together a polymeric fabric having a basis weight of from 0.2 to 2.0 ounces/yd² and a paper sheet having a basis weight in a range from 10 to 60 lbs/1300 ft², and further includes, either before or after the adhering step, impregnating the paper sheet with a first synthetic polymeric resin in an amount sufficient to render the sheet water-resistant. The first synthetic polymeric resin has an elongation at break of at least 60% by ASTM method D638. After the impregnating step, a coating layer including a second polymeric resin is applied onto the paper sheet.

### BRIEF DESCRIPTION OF THE DRAWINGS

FIG. 1 illustrates a coated paper with a reinforcing fabric in one embodiment of the invention.

FIG. 2 illustrates a cross section of the embodiment of FIG. 1.

FIG. 3 illustrates a second embodiment of a coated paper with a reinforcing fabric according to the invention.

FIG. 4 illustrates a cross section of the embodiment of FIG. 3.

### DETAILED DESCRIPTION OF THE INVENTION

This invention provides a water-resistant outdoor and indoor paper composite for billboards, signage, banners, and displays that can be printed using laser toners and water- and solvent-based inkjet inks. The composite has at least one outer paper layer bearing a coating to render it suitable for high quality inkjet and/or laser printing, and optionally comprises a reinforcing layer of lightweight polymeric fabric. Those embodiments that include the polymeric fabric have particularly good strength and tear resistance, making the product more robust during handling and mounting on a billboard or other substrate.

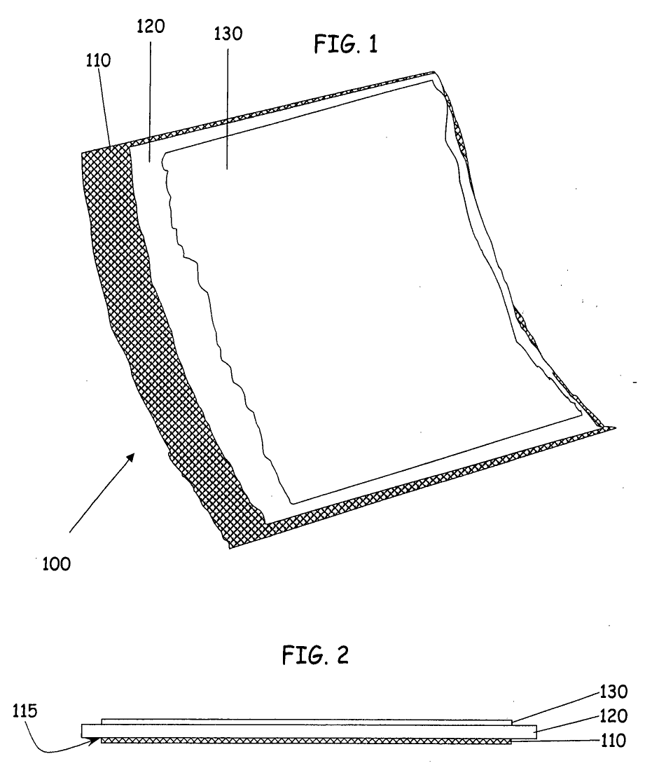

As illustrated in FIG. 1, one embodiment of the invention includes the use of a polymeric fabric adhered to a paper sheet, providing reinforcement. A composite sheet, shown generally at 100 (also shown in cross section in FIG. 2) is produced by bonding a lightweight polymeric fabric 110 to a paper sheet 120, which is impregnated with a saturant (not shown) that renders the paper water-resistant. In some embodiments, an adhesive material 115 is used to bond the polymeric fabric to the paper sheet. This bonded sheet is bears a coating 130 on the outward-facing paper surface, to protect the substrate against water and/or UV light. The coated surface may also allow inkjet inks (both water- and solvent-based) and laser printer toner to print and adhere well, further improving outdoor weatherability. If desired, a clear coating (not shown) may additionally be applied (typically as a top coat) to increase gloss and resistance to water and UV light. Final printed substrates are typically used for billboards, and thus are fairly large. Typically, the printed composite will have a rectangular shape and dimensions of at least 30 inches feet on each side.

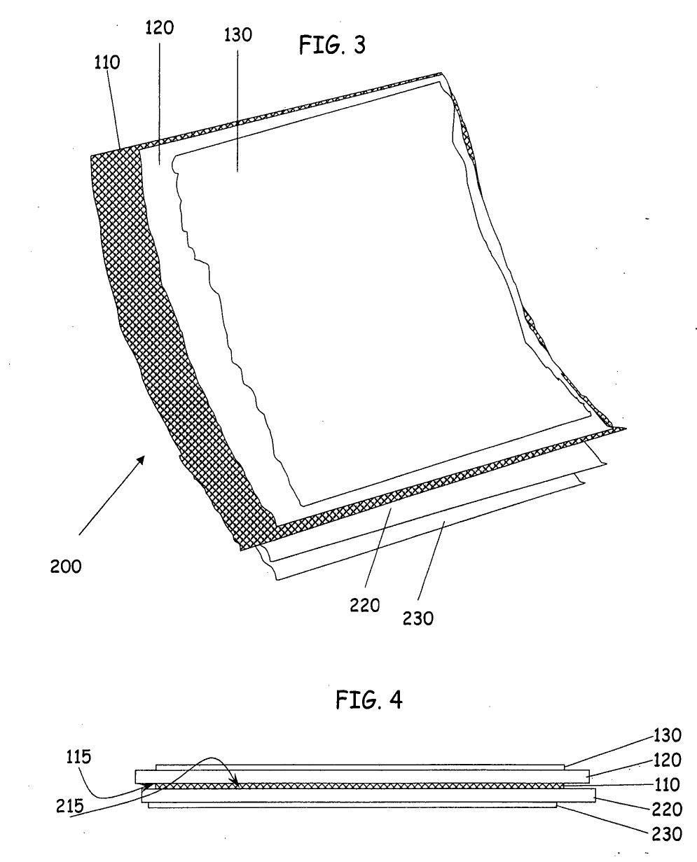

Another embodiment of the invention is illustrated in FIG. 3 (and in cross section in FIG. 4). A composite sheet, shown generally at 200, comprises a lightweight polymeric fabric 110 bonded between two paper substrate layers 120 and 220. This bonded sheet bears a coating 130, 230 such as described above on at least one outward-facing paper surface. A clear coating as described above (not shown) may also be used on either or both of the paper surfaces.

As noted above, other embodiments of the invention do not require the use of a polymeric fabric, and can be constructed as shown in FIGS. 1 and 2 with the deletion of polymeric fabric 110 and adhesive material 115.

Paper sheet 120, 220 is typically a Kraft pulp based bond paper, although any grade may be used. Typically, the basis weight will be from 10 to 60 lbs/1300 ft², and more typically from 14 to 20 lbs/1300 ft². The saturant is a synthetic polymeric resin, and is typically clear or colorless or at least very light in color, so that the saturated paper sheet 120, 220 is substantially white. Thus, dark saturants such as tar or asphalt are not examples of suitable synthetic polymeric resins for purposes of this invention. The saturants are preferably chosen so that the composite sheets are not excessively stiff, since that would make them more difficult to transport and handle, and thus the saturants typically do not include highly crosslinked, phenol-formaldehyde or other thermosetting resins such as would be used for formica or similar stiff compositions. Similarly, waxes or other hard resins would typically not be used. Suitable saturants include elastomers, and are typically thermoplastic polymers. Preferred saturants include synthetic polymers having elongation at break, using ASTM method D638, Standard Test Method for Tensile Properties of Plastics, of at least 60%. In most cases, the elongation will be at least 100%, and usually at least 300%.

Especially suitable are fully saturated polymers, i.e., those with no olefinic or aromatic unsaturation, because such resins tend to be of good stability to environmental conditions such as sunlight, etc. One exemplary saturant is HYSTRETCH® V-29 elastomeric emulsion, a fully-saturated elastomeric terpolymer available from Noveon, Inc. of Cleveland, Ohio. It is a fully saturated acrylate/acrylonitrile/acrylamide terpolymer elastomer. Other nonlimiting suitable examples include HYSTRETCH® V-43 and HYSTRETCH® V-60 emulsions.

The saturant renders the paper sheet water-resistant. As used herein, the term “water-resistant” means that the paper composite, when tested according to the water penetration test described in the Examples, has a water penetration time of at least 1.0 hour. Typically, the water penetration time will be at least 5.0 hours, and more typically at least 10.0 hours. Loading levels of the saturant are typically at least 0.07 lb of resin solids (i.e., excluding diluent in the emulsion) per pound of base paper to which it is added. More typically, the level is at least 0.1 lb/pound of paper. Typically, at most 0.25 lb is used, more typically at most 0.20 lb, and most typically at most 0.15 lb.

HYSTRETCH® V-29 fully saturated terpolymer elastomeric emulsion, HYSTRETCH® V-43 elastomeric emulsion, HYSTRETCH® V-60 elastomeric emulsion, and HYCAR® 26322 emulsion, all available from Noveon, Inc. of Cleveland, Ohio, are all suitable for impregnating the paper. Other polymeric resins available commercially as paper “saturants” may also be used, with the understanding that, as used in this invention, “polymeric resins” do not include asphalt, tar or other black or very dark resins.

Coating 130, 230 is typically a water-based emulsion coating, which may be clear or pigmented and which may optionally contain UV stabilizers or other additives. Acrylic- or aliphatic polyurethane-based coating compositions are typically used, although others may also be suitable. Generally, polymers used in the coatings will have a glass transition temperature in a range from about 6° C. to about 70° C. It has been found that such polymers more commonly have a suitable combination resistance to cracking due to handling and resistance to degradation by environmental water. Suitable polymers for this purpose include acrylic emulsion polymers LUCIDENE 602, RHOPLEX P-554, RHOPLEX E-1691, RHOPLEX HA-16, RHOPLEX HA-12, all available from Rohm and Haas of Spring House, Pa., as well as RAP-810NA and PB 6820 styrene-acrylic emulsion polymers, available from Dow Chemical of Midland Mich.

The polymeric fabric 110 comprises synthetic fibers, such as polyethylene, polypropylene, polyester, or nylon. The fabric may be woven or non-woven, and is preferably lightweight, having a basis weight of typically at least 0.2 osy (ounces/yd²), and more typically at least 0.4 or 0.5 osy as measured by ASTM method D3776. The basis weight will typically be at most 2.0 osy, more typically 1.5 or 0.7 osy. The fabric should have significant tensile strength, with machine direction and cross direction grab tensile values of at least 5 lbs being typical and at least 10 lbs being more typical, as measured by ASTM method D5034. There is no upper limit to the machine and cross direction tensile values for suitable polymeric fabrics, but in most cases the value will be no more than 100 lbs.

The polymeric fabric should also have good tear resistance. Typically, the machine direction trapezoid tear strength (ASTM method D5733) will be at least 2.0 lbs, and more typically at least 3.0 lbs or 4.0 lbs. The cross direction tear strength will typically be at least 4.0 lbs, and more typically at least 5.0 or 6.0 lbs. There is no upper limit to the machine and cross direction tear strength values for suitable polymeric fabrics, but in most cases the value will be no more than 50 lbs.

One suitable fabric is CLAF® fabric, manufactured by Atlanta Nisseki CLAF, Inc. of Kennesaw, Ga. This product is a cross-laminated polyethylene open mesh non-woven fabric produced by splitting highly biaxially stretched polyethylene films made up of three co-extruded layers (a high-density polyethylene layer sandwiched between two layers of low-density polyethylene), followed by hot-melt cross-laminating the strands. Thus CLAF® fabric is a mesh rather than a film.

The inventors have found that the tensile strength of paper composites is greatly increased by the presence of a polymeric fabric, with the tensile value of the composite being approximately that of the fabric in many cases. Similarly, the tear strength of the composite is frequently roughly that of the polymeric fabric, significantly exceeding that of the paper sheet to which it is bonded.

As a result of the high tensile and tear strength, paper composites including a polymeric fabric may be mounted on billboards by use of mechanical fasteners, such as grommets and/or nails or tacks. Although such methods are typically used for vinyl-based substrates, they are usually unsuitable for traditional paper substrates due to the ease of tearing, and thus traditional paper substrates are typically applied billboards or other surface by use of adhesives in a way that resembles the application of wallpaper. This method is also still available for the paper composites of this invention that include a polymeric fabric, thus providing a choice of how to mount them onto billboards. In any case, the paper composite is typically mounted on a billboard having a flat vertical side, but the side may instead be horizontal or angled.

The paper composite may also optionally include a continuous metallic or polymeric film (e.g., low density polythylene of about 1 mil thickness), although in some embodiments of the invention this is specifically excluded. The use of a sufficiently lightweight film, located between the paper and the polymeric fabric and adhered directly or indirectly to them, may provide additional water resistance. However, it must be emphasized that in any case a polymeric or metal film cannot be used in place of the polymeric fabric, because the properties of the resulting composite would suffer. For example, a film capable of providing the composite with sufficiently good tear and tensile strength would weigh considerably more than a suitable polymeric fabric, and this would make handling more difficult based on the weight alone as well as a tendency for the composite to have drape properties more nearly resembling the somewhat mediocre drape properties of TYVEK®, PVC film, and polypropylene film substrates. As used in this context, “polymeric film” means a self-supporting film (e.g., polyethylene) that has been applied to the paper sheet, and does not refer to polymeric materials that have been applied by coating the paper with a resin emulsion, suspension, or solution.

### Constructing the Paper Composite

In some embodiments, an adhesive material 115, 215 is used to bond the polymeric fabric to the paper layer, although heat lamination may be used to directly bond the polymeric fabric to the paper without the use of an adhesive. If an adhesive is used, it may, for example, be coated onto the paper substrate on-line using the paper machine's size press, or off-line using high speed coating equipment. The paper substrate/s 120, 220 with coated adhesive 115, 215, may then bonded to the polymeric fabric 110 using a continuous thermal roll laminator(s), although any method may be used. Typical adhesives for this purpose are liquid adhesives, often emulsion adhesives. Examples include EVA polymers. Specific suitable adhesives include, as nonlimiting examples, the emulsion polymers shown in the following table.

| ID | Source | Polymer type |
|---|---|---|
| RESYN 1601 (25- | Celanese | Vinyl acetate copolymer |
| 1601) | | |
| DUR-O-SET E-351A | Celanese | Carboxylated ethylene |
| | | vinyl acetate copolymer |
| RHOPLEX HA-12 | Rohm and Haas | Acrylic emulsion |
| Dow 620NA | Dow Chemical | Styrene butadiene |
| Hystretch V-29 | Noveon | Terpolymer |

Alternatively, adhesive 115, 215 may also be applied online in liquid form (e.g., in a solution, suspension, or dispersion) prior to the lamination process, for example by spraying or curtain coating, rod or blade coating, etc.

Coating of adhesive materials 115, 215 on-line using the paper machine's size press, or off-line using high speed coating equipment, offers the advantages of speed and cost. Coaters and size presses for paper web are inherently high speed compared to extrusion coating. In addition, low adhesive coat weight can be controlled easily. Moreover, improvement in water- and UV-light resistance, wet strength, and tear resistance can be made possible by the choices of adhesive and additives.

Saturation of the paper layer with a synthetic polymeric resin may be performed either before or after adhering the paper layer to the polymeric fabric. The polymeric resin may be applied by any means known in the art for saturating paper substrates, including for example the use of a wire-wound rod or a bent blade applicator.

### EXAMPLES

### Coating Formulations

Coating formulations were evaluated using a base sheet of highly sized, wet-strength billboard paper (50-pound/1300 ft²). Coatings were applied using machine draw down with standard wire-wound rods. Formulations with RAP-810 were electrostatic spray-coated using a Ransburg electrostatic spray demo unit from ITW Ransburg. The web speed was about 300 fpm.

All samples were tested for sheet-/print-gloss and Sutherland Wet Rub. Samples for print gloss measurement and Sutherland Wet Rub were lab coated with a black-color inkjet ink obtained from Circle Graphics LLC of Longmont, Colo. Sutherland Wet Rub testing evaluates the water resistance of the print or coating, especially resistance to abrasion when wet, and also provides a good indication of the adhesion of the ink to the coated surface under wet conditions. The Sutherland procedure is as follows:

1. Soak the test sample in a solution containing 1 gram of TRITON X 100 per liter of DI water for 1 hour.

2. Rinse the sample with DI water and attached to the Sutherland ink rub tester.

3. The Sutherland tester rubs a 4-pound weight wrapped with wet board-cloth against the sample surface until surface damage is detected.

4. The number of strokes required to damage the surface is then recorded, and the samples were rated according to the number of strokes required to damage the surface (1=Best, 10=worst).

A. Pigmented Coating

| Material | P-1 | P-2 | P-3 | P-4 | P-5 |
|---|---|---|---|---|---|
| RPS Vantage | 100 | 100 | 100 | 100 | 100 |
| TiO₂ slurry | | | | | |
| DISPEX | 0.5 | 0.5 | 0.5 | 0.5 | 0.5 |
| N-40 | | | | | |
| Triton | 0.5 | 0.5 | 0.5 | 0.5 | 0.5 |
| X-100 | | | | | |
| CELVOL | 3.5 | 3.5 | 3.5 | 3.5 | 3.5 |
| 107 | | | | | |
| RHOPLEX | 150 | | | | |
| P-554 | | | | | |
| RHOPLEX | | 150 | | | |
| HA-16 | | | | | |
| RHOPLEX | | | 150 | | |
| HA-12 | | | | | |
| RAP-810 | | | | 150 | |
| PB 6820 | | | | | 150 |
| ALCOGUM | 1.5 | 1.0 | 1.5 | 1.5 | 1.0 |
| L-251 | | | | | |
| % Solids | 44.95% | 44.72% | 44.29% | 44.18% | 44.70% |
| Brookfield | 368 | 534 | 980 | 816 | 327 |
| Visc, cps | | | | | |
| Adjusted pH | 8.65 | 8.56 | 8.83 | 9.15 | 8.51 |

RPS Vantage TiO₂ slurry is available from E. I. du Pont de Nemours and Company of Wilmington, DE.
DISPEX ® N-40 is an acrylic pigment dispersant, available from Ciba Specialty Chemicals of Tarrytown, NY.
TRITON ® X-100 is a surfactant, available from The Dow Chemical Company of Midland, MI.
CELVOL ® 107 polyvinyl alcohol is available from Celanese Corporation of Dallas, TX.
RAP-810 and PB 6820 are styrene-acrylic emulsions, available from Dow Chemical of Midland Michigan.
ALCOGUM ® L-251 is a rheology modifier, available from Alco Chemical of Chattanooga, TN.

| | P-1 | P-2 | P-3 | | |
|---|---|---|---|---|---|
| | Rhoplex | Rhoplex | Rhoplex | P-4 | P-5 |
| Properties | P-554 | HA-16 | HA-12 | RAP-810 | PB 6820 |
| Coat Weight | 2.71 | 3.51 | 3.26 | 2.76 | 3.29 |
| Sheet Gloss @ 20° | 9.3 | 8.3 | 9.0 | 9.7 | 7.2 |
| Print Gloss @ 20° | 28.6 | 20.5 | 19.0 | 23.8 | 14.2 |
| Sheet Gloss @ 75° | 63.2 | 56.9 | 62.0 | 64.8 | 51.8 |
| Print Gloss @ 75° | 93.4 | 86.3 | 89.4 | 91.5 | 80.5 |
| Sutherland Wet | 4 | 3 | 8 | 9 | 7 |
| Rub* | | | | | |

*1 = best, 10 = worst

B. Clear Coating

| Material | C-1 | C-2 | C-3 | C-4 |
|---|---|---|---|---|
| TRITON X-100 | 0.5 | 0.5 | 0.5 | 0.5 |
| CELVOL 107 | 3.5 | 3.5 | 3.5 | 3.5 |
| RHOPLEX E-1691 | 150 | | | |
| LUCIDENE 602 | | 150 | | |
| RAP-810 | | | 150 | |
| PB 6820 | | | | 150 |
| ALCOGUM L-251 | 1.0 | 0.5 | 0.5 | 0.5 |
| % Solids | 39.26% | 40.51% | 44.17% | 44.63% |
| Brookfield Visc, cps | 684 | 908 | 2200 | 1028 |
| Adjusted pH | 9.00 | 8.59 | 8.56 | 8.83 |

| | C-1 | C-2 | | C-4 | |
|---|---|---|---|---|---|
| | Rhoplex | Lucidene | C-3 | PB | Control |
| Properties | E-1691 | 602 | RAP-810 | 6820 | Raw Stock |
| Coat Weight | 1.48 | 4.03 | 3.30 | 3.07 | 0 |
| Sheet Gloss @ 20° | 19.6 | 19.8 | 21.4 | 21.1 | 5.5 |
| Print Gloss @ 20° | 48.1 | 22.2 | 30.5 | 30.0 | 10.1 |
| Sheet Gloss @ 75° | 73.6 | 66.0 | 85.0 | 77.6 | 32.9 |
| Print Gloss @ 75° | 101.4 | 86.4 | 103.4 | 99.6 | 65.1 |
| Sutherland Wet | 1 | 2 | 10 | 6 | 5 |
| Rub* | | | | | |

*1= best, 10 = worst

### Saturant Evaluation

Three emulsion polymers were chosen for the saturation study: HYCAR® 2679 Emulsion Acrylic emulsion, HYSTRETCH® V-29 Elastomeric emulsion, and RHOPLEX® B-153 Acrylic polymer.

Two bases were used for this study: a 18-pound non-sized bond, with no surface starch applied, and a CLAF®-reinforced base paper, from Jen-Coat Inc. of Westfield, Mass. Jen-Coat manufactures the CLAF® reinforced paper for envelope application, using an extruded EVA adhesive layer to bond CLAF to the base paper. The emulsions were saturated at two concentrations, using grooved Mayer rods. The emulsions were diluted to 30% solids and pH to 8.0-9.0. The saturated base papers were dried with forced air.

Water resistance of the saturated base was determined by the Water Penetration Test shown below.

### Water Penetration Test

1. Samples for testing should be fully conditioned, to TAPPI specifications. (At least 8 hours at 20% relative humidity, followed by 24 hours at 50% relative humidity)

2. Cut samples 8×8 inch square for testing. They should not have any folds, wrinkles or other blemishes.

3. With the coated side (or the surface that will come in contact with water) up, fold edges to form a 1-inch high wall around the sample.

4. Fold the corners and staple in such a manner as they will hold water.

5. Fill the graduated cylinder to 100 ml with room temperature distilled water.

6. Pour the water from the graduated cylinder into the boat and start the stopwatch at the same time.

7. Observe the bottom of the boat for a change of opacity. This indicates the absorption of water.

8. Note and record the time when water absorption is first observed. If no water leakage was observed, the experiment is terminated after 72 hours.

Water Penetration Testing was performed on base sheets impregnated with the following saturants. The results showed that the non-sized paper saturated with HYSTRETCH® V-29 had the best water resistance property. HYCAR® 2679, a heat-reactive acrylic from Noveon, Inc. also performed well.

| | Coating | | |
|---|---|---|---|
| Emulsion | Solids | Viscosity | pH |
| HYCAR 2679 | 29.98% | 53.4 | 8.78 |
| HYSTRETCH V-29 | 29.68% | 44.0 | 8.52 |
| RHOPLEX B-15J | 30.12% | 55.2 | 8.58 |

| | Base paper | |
|---|---|---|
| | 18# | 25# CLAF |
| Water penetration time, hr. | Non- | from Jen |
| Basis weight, #/1300 ft² | sized base | Coat^{£} |

| % of Paper Basis Wt.* | 15% | 30% | 10% | 20% |
|---|---|---|---|---|
| Emulsion weight per 1300 ft² | 2.7 | 5.4 | 2.5 | 5.0 |
| Emulsion | | | | |
| HYCAR 2679 | 4.50 | 6.00 | 0.13 | 0.17 |
| HYSTRETCH V-29 | 14.00 | 16.50 | 0.08 | 0.13 |
| RHOPLEX B-15J | 0.17 | 0.42 | 0.17 | 0.20 |

*Samples Saturated on both Sides.
^{£}Water appeared to wick to the first break in the coating. When tested on the CLAF side of the sample, the penetration time was stopped at 72 hours with no indication of water penetration.

It is apparent from the above results that applying the saturants by wound wire rod drawdown was effective for the 18 lb/1300 ft² base stock, but not for the CLAF®-adhered paper. However, the inventors have found that a bent-blade coater can be used effectively for both types of substrate.

### Environmental Exposure Testing

A bent blade coater was used to apply HYSTRETCH® V-29 polymer emulsion to 15 lb/1300 ft² low-sized uncoated bond paper. At 20 to 25 psi pressure, the bent blade was able to saturate the sheet well to produce a polymer loading level of about 1.6 pounds/1,300 ft².

Two coating formulations were used as solvent inkjet media topcoat: P-2-1 white and C-1-2 clear, as shown below.

Coating Formulations

| Material | P-2-1 | C-1-2 |
|---|---|---|
| RPS Vantage TiO₂ slurry | 39.1 | |
| RHOPLEX HP1055 | | |
| ALBAGLOS S pptd. CaCO₃ | | |
| DISPEX N-40 | 0.2 | |
| TRITON X-100 | 0.2 | 0.3 |
| CELVOL 107 | 1.4 | 2.3 |
| RHOPLEX HA-16 | 58.7 | |
| RHOPLEX E-1691 | | 97.4 |
| RM 232 | 0.4 | |
| Total | 100.0 | 100.0 |

ALBAGLOS ® S pptd. CaCO₃ is available from Minerals Technologies Incorporated.

Wet Coating Properties

Coating
ID

| | P-2-1 | C-1-2 |
|---|---|---|
| Initial Viscosity, cps. | 53 | 70 |
| Initial pH | 5.60 | 3.52 |
| Initial Solids, % | 34.97 | 34.04 |
| Adjusted Solids, % | 30.08 | 30.08 |
| Adjusted pH | 8.52 | 8.61 |
| Adjusted Viscosity, cps. | 42 | 27 |
| Surface Tension | 37.1 | 39.7 |
| Opacity @ 1.3# coat | 97.55 | 96.16 |
| weight | | |

Note:
Base paper opacity = 95.72

The resulting saturated and coated rolls were coated with DUR-O-SET E-351 carboxylated EVA adhesive (available from Celanese Corporation of Dallas, Tex.) on the back side to improve adhesion to the CLAF®, and then extrusion laminated to CLAF® LS polymer fabric, with a 1-mil low density polyethylene film laminated between the paper stock and the CLAF® for extra strength, using a 0.5-mil EVA tie layer between the film and the CLAF® and another between the film and the paper.

Representative samples using the clear topcoat (C-1-2) were printed at a commercial sign shop with a Mimaki IV3-160SP solvent inkjet printer, and samples of the printed product were subjected to accelerated weathering tests using a QUV Accelerated Weathering Tester, available from Q-Lab Corporation of Cleveland, Ohio. The test protocol involved alternating 2-hour exposure to UV-light with 15-minute periods under condensation (water), up to 500 hours, with no visible damage. Additionally, 1-week UV exposure test was performed, with no detectable fading.

Although the invention is illustrated and described herein with reference to specific embodiments, the invention is not intended to be limited to the details shown. Rather, various modifications may be made in the details within the scope and range of equivalents of the claims without departing from the invention.

What is claimed:

1. A paper composite comprising:
a first paper sheet having a first side and a second side, said paper sheet impregnated with a first synthetic polymeric resin in an amount sufficient to render the sheet water-resistant; and
a coating layer on said first side of said paper sheet, said coating layer comprising a second polymeric resin;
wherein the paper sheet has a basis weight in a range from 10 to 60 lbs/1300 ft² and the first synthetic polymeric resin has an elongation at break of at least 60% by ASTM method D638.

2. The paper composite of claim 1, wherein the first synthetic polymeric resin is present at a level of at least 0.07 lb of resin per pound of paper.

3. The paper composite of claim 1, wherein the first synthetic polymeric resin does not comprise olefinic or aromatic unsaturation.

4. The paper composite of claim 1, wherein the first synthetic polymeric resin is an elastomer.

5. The paper composite of claim 1, wherein the first synthetic polymeric resin is selected from the group consisting of acrylic resins, epoxy resins, polyurethane resins, and copolymers of any of these.

6. The paper composite of claim 1, wherein the second polymeric resin is an acrylic resin or an aliphatic polyurethane resin.

7. The paper composite of claim 1, wherein the second polymeric resin has a glass transition temperature in a range from about 6° C. to about 70° C.

8. The paper composite of claim 1, wherein the paper composite further comprises a layer of a polymeric fabric having a first side and a second side and having a basis weight of from 0.2 to 2.0 ounces/yd², wherein the first side of the polymeric fabric is adhered to the second side of the paper sheet.

9. The paper composite of claim 8, wherein the polymeric fabric is a nonwoven fabric.

10. The paper composite of claim 8, wherein the polymeric fabric comprises oriented polyethylene.

11. The paper composite of claim 8, wherein the polymeric fabric comprises a cross-laminated polyethylene open mesh nonwoven fabric.

12. The paper composite of claim 8, wherein the first polymeric resin is an elastomer that does not comprise olefinic or aromatic unsaturation, and the second polymeric resin is an acrylic resin or an aliphatic polyurethane resin having a glass transition temperature in a range from about 6° C. to about 70° C.

13. The paper composite of claim 1, further comprising a second layer of paper adhered to said second side of said polymeric fabric.

14. The paper composite of claim 1, further comprising a visible pictorial or textual image thereon, said paper composite having a rectangular shape and dimensions of at least 30 inches on each side.

15. A method of applying a visible textual or pictorial image to a billboard, comprising the steps of:
1) providing a billboard comprising a flat side; and
2) attaching a substantially coextensive paper composite onto the flat side, the paper composite comprising:
a first paper sheet having a first side and a second side, said paper sheet impregnated with a first synthetic polymeric resin in an amount sufficient to render the sheet water-resistant; and
a coating layer on said first side of said paper sheet, said coating layer comprising a second polymeric resin;
wherein the paper sheet has a basis weight in a range from 10 to 60 lbs/1300 ft² and the first synthetic polymeric resin has an elongation at break of at least 60% by ASTM method D638, and wherein the paper composite bears thereon the visible pictorial or textual image.

16. The method of claim 15, wherein the image is an inkjet image or laser-printed image.

17. The method of claim 15, wherein the step of attaching comprises attaching with an adhesive.

18. The method of claim 15, wherein the step of attaching comprises attaching with mechanical fasteners.

19. The method of claim 15, wherein the paper composite further comprises a polymeric fabric having a basis weight of from 0.2 to 2.0 ounces/yd².

20. A method of forming a paper composite, comprising the steps of:
adhering together a polymeric fabric having a basis weight of from 0.2 to 2.0 ounces/yd² and a paper sheet having a basis weight in a range from 10 to 60 lbs/1300 ft²; and
either before or after the adhering step, impregnating the paper sheet with a first synthetic polymeric resin in an amount sufficient to render the sheet water-resistant and thereafter applying a coating layer onto the paper sheet, said coating layer comprising a second polymeric resin;
wherein the first synthetic polymeric resin has an elongation at break of at least 60% by ASTM method D638.

21. The method claim 20, wherein the adhering step comprises applying a liquid adhesive.

22. The method of claim 20, wherein the adhering step comprises thermally laminating.
